(19) United States
(12) Patent Application Publication
(10) Pub. No.: US 2004/0208962 A1
(43) Pub. Date: Oct. 21, 2004

(54) High protein peanut butter and jelly sandwich and method of making the same

(75) Inventors: Duane Nathan Eberhart, Wooster, OH (US); Steven Blair Larsen, Massillon, OH (US)

Correspondence Address: Fay, Sharpe, Fagan,, Minnich & McKee, LLP, 7th Floor, 1100 Superior Avenue, Cleveland, OH, 44114-2518, US

(73) Assignee: The J.M. Smucker Company, an Ohio corporation

(21) Appl. No.: 10/413,811

(22) Filed: Apr. 15, 2003

(51) Int. Cl. A23G 3/00

(52) U.S. Cl. 426/275

(57) ABSTRACT

A crustless sandwich made from two slices of baked bread. The sandwich includes first and second matching crustiess bread pieces. The bread pieces have the same general outer shape defined by an outer periphery with central portions surrounded by an outer peripheral area, the bread pieces being at least partially crimped together at the outer peripheral area. A central composite food layer is positioned between the central portions of the bread pieces and spaced inwardly of the crimped outer periphery area. The composite food layer includes a first and second layer of a first food spread and a second food spread that is substantially encapsulated between the first and second layer of the first food spread. The first food spread is nutritionally enhanced.

The present invention relates to sandwiches, and more specifically, it relates to a sealed sandwich for providing a convenient sandwich which can be stored for long periods of time without a central filling leaking outwardly, and even more specifically to a peanut butter and jelly sandwich having a high protein content.

### INCORPORATION BY REFERENCE

There are numerous prior art sandwiches and methods and devices used to make such sandwiches. Such patents include U.S. Pat. Nos. 2,780,163; 3,690,898; 3,782,270; Des. 252,536; Des. 293,040; Des. 317,672; Des. 318,360; 4,608,918; 5,112,632; 5,387,149; 5,500,234; 6,004,596, all of which are incorporated herein by reference. In addition, the prior art includes several patents relating to the manufacture and formulation of peanut butter. Such patents include, U.S. Pat. Nos. 6,312,754; 6,153,250; 6,063,430; 5,942,275; 5,885,646; 5,693,357; 5,591,477; 5,518,755; 5,508,057; 5,490,999; 5,433,970; 5,240,734; 4,814,195; 4,288,378; 4,000,322; and 3,995,068, all of which are incorporated herein by reference.

### BACKGROUND OF INVENTION

For many years, hors d'oeuvres and other types of crustless sandwiches have been made by cutting pieces of baked bread into a desired shape and placing a food substance between the two cut pieces. Sometimes the cook manually crimped the pieces together. Early on, this home technique involved a combined cutter device and crimper or merely a squeezing blade. These devices were used in home kitchens and did not allow optimum formation of a seal between the two bread layers. The seal between bread pieces was caused by the starch content of the breads. Such hand operated processes for producing crustless sandwiches with seal peripheries were not adapted for mass production to produce retail volumes of crustless sandwiches that must maintain a seal and good appearance over long times. The peripheral seal obtained by prior procedures used in the home, restaurants and other catering establishments did not guarantee a substantially complete seal around the periphery of the sandwich. The edge would “fish mouth”. The seal was unimportant. The sandwich was consumed at once. Any imperfections were of no significance. If the bread did not hold together, the person making the hors d'oeuvre or sandwich would merely manually squeeze the unsealed portion. It was found that the prior procedures resulted in the bread memory and improper seal causing an opening of the edges of the sandwich after long storage. In addition, internal spreads or coatings migrated to the edges to prevent the bread-to-bread contact for good sealing integrity.

One early device that was used to make crustless sandwiches is disclosed in Sollerud 3,782,270. Sollerud discloses the manufacture of a toasted crustless sandwich. This patent discloses an open frame to accommodate a rotating press plate to roll over the bread slices so the outermost edges of the two superimposed slices of bread are squeezed off. The bevel and corresponding lower recess of the press plate successively increase the compression pressure toward the outer edges of the slice of bread being squeezed off. This bread squeezing action caused a progressive pinching that resulted in a thin squeezed shut seam. Apparently, due to the realization of the inconsistencies and the lack of an adequate peripheral seal obtainable by manual devices for creating crustless sandwiches, the automated process shown in Sollerud abandoned the concept of crimping flat peripheral areas as the bread was cut. This automatic machine merely pinched off or squeezed bread slices until the crust was separated and hopefully the small sealing area would hold. But, this type of process formed a very narrow sealing area that lacked integrity and had a pressure gradient inward of the edge. Such process was not usable technology for mass producing crustless sandwiches for retail distribution. There was no peripheral area sealed or crimped. Consequently, the bread slices were separated by a squeezing action and not a combined cut and then crimped process. This squeezing action distorted the periphery of the crustless sandwich but did not guarantee integrity between the bread slices. Only a small squeezed seam holds the bread together. For the purposes of disclosing a dispensing procedure and the mechanism for dispensing a food spread between two bread slices, Sollerud is incorporated by reference herein as background information. Sollerud also disclosed a filling of a strand of butter that was squeezed about a jam. The outer tube of butter was used to prevent the jam from coming into contact with the bread, which was not desirable because of the property of the jam. Sollerud does not use the butter as a companion diverse food constituent, but merely as a protective barrier for the jam. Sollerud makes a product to be toasted. This is not consistent with peanut butter and jelly sandwiches. The peanut butter would melt and create a mess. Sollerud merely discloses jam that needs a barrier. A toasted jam sandwich is not appealing to many children and possibly explains the lack of commercial impact of the 1974 patent. There is no indication that Sollerud was making a peanut butter and jelly sandwich. Sollerud was directed to a butter and jelly sandwich that is commonly consumed by adults, and much less so by children.

To overcome all of these disadvantages of domestic, manual and automated techniques for producing crustless sandwiches, the concept shown in Kretchman 6,004,596 was developed. In recent years, a tremendous volume of crustless sandwiches has been mass produced for retail distribution using the technique disclosed in Kretchman 6,004,596. The Kretchman patent discloses the novel concept of producing an inexpensive retail type snack having nutritional values consistent with healthy eating between meals. The novel concept starts with the tradition and desirability of the popular peanut butter and jelly sandwich. One of the more popular lunch foods for children and adults is the peanut butter and jelly sandwich. These sandwiches are simple to prepare and are enjoyed by all ages. Younger adults commonly request the crust be removed, since such adults have not yet acquired a taste for the outer crust of the bread. Although these sandwiches are easy to make, working parents typically want to prepare a younger adult's lunch the night before so that there is less rush in the morning. In addition, many parents like to pre-prepare snacks for their children and store such snacks in the refrigerator or freezer for later use. Peanut butter and jelly sandwiches have posed a significant problem in pre-preparation in that the bread becomes soggy over time, even when the sandwich is stored in a refrigerator or freezer. As such, peanut butter and jelly sandwiches were typically made just prior to eating or in the morning for that day's lunch.

Prior to Kretchman, is was not possible to make a standard peanut butter and jelly sandwich for freezing and retail distribution. The Kretchman invention solved this long felt commercial need. To inhibit or prevent the jelly from leaching and causing deterioration of the supporting bread, jelly was placed between two layers of peanut butter so the outer edges of peanut butter at least partially seal around the center jelly layer. This construction presented a filling located inward of the first and second perimeter surfaces of two bread portions. These perimeter surfaces were coplanar to give surface-to-surface contact and substantially free of both jelly and the surrounding peanut butter. This novel concept involved an encapsulated center deposited food layer surrounded by bread pieces cut from standard baked bread. After the pieces had been cut with matching shapes from separate bread slices, they were crimped together at their outer edges so the crimped area was at least partially spaced from the center composite food layer. This produced a bread-to-bread sealed joint around the composite food layer. The cut and subsequent sealing action created the novel sandwich of the Kretchman patent. The bread slices were cut to provide defined bread portions having peripheral or marginal edges that are surface sealed and crimped. The resulting crustless sandwich was then packaged, frozen and distributed commercially. The sandwich constructed by Kretchman could be stored for long periods of time without an inner filling seeping into the bread portions. To facilitate and take advantage of the prevention of seepage, the sandwich was typically hermetically sealed in a package for long term storage, such as in the freezer of a retail outlet or in a home awaiting consumption. The technique shown in Kretchman is now used for mass producing crustless sandwiches hermetically packaged for retail distribution. The most popular of crustless sandwiches using the Kretchman technique is a peanut butter and jelly version, wherein a layer of peanut butter is placed on opposite sides of a layer of jelly. The technology disclosed in Kretchman has resulted in a commercially successful peanut butter and jelly sandwich ideally directed toward consumption as snacks or lunch by children and busy adults.

Over the last several years, the Food and Drug Administration and other health organizations have been promoting the need for increased protein consumption by young and older adults and to control the caloric intake of young and older adults. As such, certain foods having a higher protein content have been promoted for use in school lunch cafeterias. In addition, foods having a lower caloric intake have also been promoted in school lunch cafeterias. Higher protein foods and foods with reduced calories have also been increasingly demanded by parents. Various nutritional guidelines have been increasingly adapted in an effort to improve the nutritional intake of young adults. Unfortunately, young adults can be very particular concerning the types of foods they will consume. As a result, there is a constant balance maintained between the nutritional value of the food offered to young adults and the food that will actually be consumed by the young adults during a meal. The peanut butter and jelly sandwiches offered by Assignee under the trademark UNCRUSTABLES have been widely accepted by many parents and school lunch programs. The acceptance of these sandwiches by young adults has driven the increase in demand for these sandwiches. Peanut butter is a known source of protein. As such, the peanut butter and jelly sandwiches provide a needed source of protein to young and older adults. Peanut butter is also a very popular food of young adults. As a result, UNCRUSTABLES have been increasingly offered in school lunch programs and by parents as a lunch or snack food. Although UNCRUSTABLES have provided a needed source of protein to young and older adults alike, typically only a single sandwich is provided to a young adult at lunch school programs and at other activities. The protein in the UNCRUSTABLES, though significant, still must be supplemented to provided young adults with the recently recommended protein consumption levels. Consequently, there is a continued need for higher nutritional valued foods with less caloric content.

### THE INVENTION

The present invention relates to a nutritional food product and method and apparatus for making the same, and more particularly to a protein fortified food product, and even more particularly to sandwiches that include protein fortified nut butter having reduced calories, and still even more particularly to sealed crustless sandwiches that include protein fortified nut butter having reduced calories and which can be stored for long periods of time without the central filling leaking outwardly.

In one aspect of the present invention, there is provided an improved nut butter that can be used to make more nutritional food products such as, but not limited to, peanut butter and jelly sandwiches. The term “jelly” is defined as including any type of fruit spread, such as, without limitation, jams, jellies and preserves. Although not typically referred to as “jelly”, for purposes of this invention, the term “jelly” also includes other types of spreads such as, but not limited to, honey, cheese spread, butter, syrup or toppings (i.e., maple, chocolate, cherry, apricot, marshmallow, etc.), and the like. The term “jelly” does not include nut butter. The components of nut butter typically include nut particles, nut oil, and salt. The nut butter can include additional ingredients such as, but not limited to, other oils, stabilizers, emulsifiers, fortifying materials, sweeteners, hydrophilic additives, etc. The nuts that form the nut oil and/or nut particles are commonly peanuts; however, other nuts and/or grains can be used such as, but not limited to, almonds, cashews, pine nuts, macadamia nuts, sunflower seeds, etc. The nuts are typically prepared by milling clean (blanched) kernels of roasted nuts. Various patents describe methods of milling nuts, such as U.S. Pat. No. 2,302,574, which is incorporated herein by reference. The nuts typically have about 40-60 weight percent solids, the solids being a combination of protein and carbohydrate. The remaining material is nut oil. When ground, the nut oil is typically pressed out of the solids, so as to have a suspension of small solid particles in the nut oil. This nut butter product is normally combined with a wide variety of additives to improve texture, taste, appearance and stability prior to being sold commercially. An edible oil can be added to the nut oil and nut particle mixture. Such oils typically include a vegetable oil or a partially hydrogenated vegetable oil such as, but not limited to, peanut oil, corn oil, cotton seed oil, rice oil, coconut oil, sunflower oil, olive oil, canola oil, soy bean oil, and/or other equivalent edible oils. An emulsifier or other type of stabilizer can also be added to the nut oil and nut particle mixture to stabilize the nut butter. Such emulsifiers and/or stabilizers that can be use include, but are not limited to, polyglycerol (e.g., decaglycerol tetraoleate, triglycerol monooleate, decaglycerol, tristearate, etc.), high melting saturated fatty acid glycerides, lecithin and/or the like. A sweeter can be added to the nut oil and nut particle mixture. Such sweeteners include, but are not limited to, corn syrup, honey, sucrose, dextrose, levulose, molasses, maple syrup, sweetose, NutraSweet, Saccharine, and/or the like. Salt is also typically added to the nut oil and nut particle mixture (e.g., sodium chloride). Various “fortifying materials” can be added to the nut oil and nut particle mixture such as, but not limited to, iron, thiamin, riboflavin, Vitamin E, and/or any number of other minerals and vitamins. Anticrystallization agents can also be included in the nut oil and nut particle mixture composition (e.g., sorbitol, propylene glycol, oxystearin and glycerol). In one embodiment of the invention, the nut butter is modified to lower the caloric value of the nut butter, reduce the fat content of the nut butter, and/or increase the protein content of the nut butter. Standard peanut butter products generally include about 60-100 weight percent nut butter (nut solids and nut oil), and typically about 60-98, more typically about 70-98 weight percent of the total composition. The added oil, if any, is generally about 1-24 weight percent, and typically about 2-20 weight percent of the total final composition. The stabilizer, if added, is generally about 0.1-3 weight percent, and typically about 0.5-2.5 weight percent of the total final composition. The sweetener, if added, is generally about 1-25 weight percent, and typically about 1-10 weight percent based on the entire final composition. The salt, if added, is generally added to taste and is about 0.01-2 weight percent, and typically about 0.1 to 1 weight percent based on the final composition. As indicated above, the nut butter is formed by first combining the dry ingredients, such as roasted nuts, and if used, salt, sweetener, stabilizer and/or other dry ingredients, and thereafter milling the ingredients. The milled ingredients are generally discharged from the milling device at a temperature usually in excess of 130° F.; however, other temperatures can be used. The milling of the dry ingredients is selected to form a smooth or chunky nut butter. After milling of the dry ingredients has occurred, the other components of the nut butter, if any, are added and mixed together. Mixing can be accomplished in a static in-line mixer or other types of mixers. Once the mixture has achieved the desired texture and homogeneity, it can then transferred, conveniently by means of a pump, into the containers, while maintaining the mixture at a temperature of at least about 85° F. Thereafter, the nut butter is cooled. Such cooling of the mixture can be accomplished by a heat exchanger or the like. As can be appreciated, the nut butter can be directed into a receptacle for further processing and/or be introduced in a food line that applies the nut butter to a food product.

In another and/or alternative aspect of the present invention, the nut butter is fortified to increase the nutritional value of the nut butter. Nuts are known to include fat, carbohydrates, and protein. Many nuts also include various amounts of calcium and iron. In one embodiment of the invention, one or more protein supplements are added to the nut butter. The protein supplement can include, but is not limited to, added nut solids, soy flour, soy concentrate, soy isolate, soy lecithin, soy nuts, pea protein, casein, caseinates, keratin, albumens, dairy proteins (e.g., dry milk, butter milk, butter milk solids, evaporated milk, cream, whey proteins, etc.), grain proteins (e.g. wheat gluten, rice proteins, etc.), collagen, lecithins, fibroin, sclerolin, myosin, actin, carboxypeptidase, trypsin, ovalbumin, egg whites, and/or protein from other animal and/or vegetable sources. The one or more protein supplements can added during the manufacture of the nut butter, and/or can be combined with a manufactured nut butter. In one aspect of this embodiment, one or more protein supplements are added mixed with the components of the nut butter to form a protein fortified nut butter after mixing together all of the ingredients of the nut butter. If one or more of the protein supplements is a dry component, the protein supplements can be added to the nuts during the milling process. If one or more of the protein supplements is a liquid or semi-liquid component, the protein supplement can be mixed in a mixer with the milled nuts. In another and/or alternative aspect of this embodiment, the one or more protein supplements can be added to a finished nut butter product. In this aspect of the embodiment, an existing nut butter product is combined with one or more protein supplements. The one or more protein supplements can be in a liquid or dry form. The one or more protein supplements are typically combined with the nut butter in a mixer. The nut butter can be heated during the mixing process to facilitate in the proper and/or timely mixing of the one or more protein supplements with the peanut butter. In another and/or alternative embodiment of the invention, one or more vitamin and/or mineral supplements are added to the nut butter. The vitamin and/or mineral supplement can be added during the manufacture of the nut butter, and/or can be combined with a manufactured nut butter. The one or more vitamins and/or minerals that can be included in the nut butter can include, but are not limited to, Vitamin A, biotin, Vitamin C, pantothenic acid, calcium, phosphorus, iron, iodine, Vitamin D, magnesium, Vitamin E, zinc, Vitamin K, selenium, thiamin, copper, riboflavin, potassium, sodium, manganese, niacin, chromium, Vitamin B6, molybdenum, folate, chloride, and/or Vitamin B12. In one aspect of this embodiment, one or more vitamin and/or mineral supplements are added mixed with the components of the nut butter to form a vitamin and/or mineral fortified nut butter after mixing together all of the ingredients of the nut butter. If one or more of the vitamin and/or mineral supplements is a dry component, the one or more vitamin and/or mineral supplements can be added to the nuts during the milling process. If one or more of the vitamin and/or mineral supplements is a liquid or semi-liquid component, the vitamin and/or mineral supplement can be mixed in a mixer with the milled nuts. In another and/or alternative aspect of this embodiment, the one or more vitamin and/or mineral supplements can be added to a finished nut butter product. In this embodiment, an existing nut butter product is combined with one or more vitamin and/or mineral supplements. The one or more vitamin and/or mineral supplements can be in a liquid or dry form. The one or more vitamin and/or mineral supplements are typically combined with the nut butter in a mixer. The nut butter can be heated during the mixing process to facilitate in the proper and/or timely mixing of the one or more vitamin and/or mineral supplements with the peanut butter. In still another and/or alternative embodiment of the present invention, fiber is added to the nut butter. The fiber can added during the manufacture of the nut butter, and/or can be combined with a manufactured nut butter. The fiber can include, but is not limited to, insoluble fiber from fruits, vegetables, dried beans, wheat bran, seeds, popcorn, brown rice, and/or whole grain products (e.g. breads, cereals, pasta, etc.), and/or soluble fiber from fruits (e.g. apples, oranges, pears, peaches, prunes, grapes, etc.), vegetables, seeds, oat bran, dried beans, oatmeal, barley and/or rye. Specific non-limiting examples of fiber that can be included in the nut butter include wheat fiber, psyllium husk, cellulose, inulin, cellulose, hemicellulose, lingnin, gum, and/or pectin.

In still another and/or alternative aspect of the present invention, the caloric content of the nut butter is reduced and the nutritional value of the nut butter is increased. One type of nut butter is peanut butter. A two (2) tablespoon serving of peanut butter typically has about 185-195 calories, about 15.5-16.5 grams of fat and about 7.5-8.5 grams of protein. A typical peanut butter and jelly sandwich includes about 2-4 tablespoons of peanut butter. As such, the caloric, fat and protein content of the peanut butter of a typical peanut butter and jelly sandwich is about 185-390 calories, about 15.5-33 grams of fat, and about 7.5-17 grams of protein. The present recommended dietary allowances for kids and adolescents is as follows:

| Nutrient | Boy/Girl 4-6 (44 lbs.) | Boy/Girl 7-10 (62 lbs.) |
|---|---|---|
| Calories | 1800 | 2000 |
| Protein (g) | 24 | 28 |
| Fat (g) | 60 | 66 |

| | |
|---|---|
| Boys | Girls |

| | 11-14 | 15-18 | 11-14 | 15-18 |
|---|---|---|---|---|
| Nutrient | (99 lbs.) | (145 lbs.) | (101 lbs) | (120 lbs.) |
| Calories | 2500 | 3000 | 2200 | 2200 |
| Protein (g) | 45 | 59 | 46 | 44 |
| Fat (g) | 83 | 100 | 73 | 73 |

A comparison of the present recommended dietary allowances for kids and adolescents to the protein content of peanut butter in a typical peanut butter and jelly sandwich reveals that the consumption of a single peanut butter and jelly provides about 26-70% of the present recommended dietary allowance of protein and about 23-55% of the present recommended dietary allowance of fat for boys/girls of 4-10 years old and about 12.5-38% of the present recommended dietary allowance of protein and about 15-45% of the present recommended dietary allowance of fat for boys/girls of 11-18 years old. One aspect of the present invention is to increase the nutritional value of the nut butter such as, but not limited to, increasing the protein content of the nut butter while simultaneously maintaining or reducing the caloric and/or fat content of the nut butter. By enhancing the nut butter in such a manner, the nut butter will be better able to provide the needed protein to adolescents upon the consumption of the nut butter. In one embodiment of the present invention, the peanut butter is formulated and/or modified to reduce the fat and caloric content of the nut butter and increase the protein content of nut butter. In one aspect of this embodiment, the caloric content of the nut butter is reduced by up to about 30%, typically reduced by up to about 20%, more typically reduced by up to about 2-20%, even more typically reduced by up to about 2-15%, and still even more typically reduced by up to about 5-10%. In another and/or alternative aspect of this embodiment, the protein content of the nut butter is increased by up to about 60%, typically increased by up to about 50%, more typically increased by up to about 5-40%, even more typically increased by up to about 5-35%, still even more typically increased by up to about 10-30%, and yet even more typically increased by up to about 20-30%. In still another and/or alternative aspect of this embodiment, the fat content of the nut butter is reduced by up to about 40%, typically reduced by up to about 30%, more typically reduced by up to about 1-25%, even more typically reduced by up to about 4-25%, still even more typically reduced by up to about 8-25%, and yet even more typically reduced by up to about 12-25%. In yet another and/or alternative aspect of this embodiment, a protein supplement is added to the nut butter. The addition of the protein supplement increases the protein content of the nut butter per serving, and results in a reduction of the fat and the caloric content of the nut butter per serving. In one specific formulation of this aspect, the protein supplement constitutes about 0.5-40 weight percent of the final nut butter product. In another and/or alternative specific formulation of this aspect, the protein supplement constitutes about 1-25 weight percent of the final nut butter product. In still another and/or alternative specific formulation of this aspect, the protein supplement constitutes about 5-20 weight percent of the final nut butter product. In yet another and/or alternative specific formulation of this aspect, the protein supplement constitutes about 10-20 weight percent of the final nut butter product.

In still another and/or alternative aspect of the present invention, a pre-made nut butter product is subsequently modified to reduce the caloric content of the nut butter and increase the nutritional value of the nut butter. Many pre-made nut butter products are commercially available. For example, a pre-made nut butter, such as peanut butter, is commercially available under well-known brand names such as JIF®, PETER PAN®, SKIPPY®, etc. These or other pre-made nut butter products can be combined with one or more ingredients to reduce the caloric content per serving of the nut butter, to reduce the fat content per serving of the nut butter, and to increase the nutritional value of the nut butter per serving. In one embodiment of the invention, a protein supplement and one or more flavoring agents are added to the pre-made nut butter product to reduce the caloric content per serving of the final or modified nut butter, to, reduce the fat content per serving of the final or modified nut butter, and to increase the protein content of the final or modified nut butter per serving. In one aspect of this embodiment, the flavoring agents include, but are not limited to salt (e.g. sodium chloride, potassium chloride, etc.), sweetener (e.g. corn syrup, honey, sucrose, dextrose, levulose, maple syrup, sweetose, NutraSweet, Saccharine, Asparame, etc.), spices (e.g., cinnamon, nutmeg, cloves, allspice, etc.), flavoring extracts (e.g., vanilla extract, almond extract, etc.), vegetable juices and/or flavorings, fruit juices and/or flavorings, etc. In one non-limiting specific formulation of this aspect, the protein supplement constitutes about 1-25 weight percent of the final nut butter product, typically about 5-20 weight percent of the final nut butter product, and more typically about 10-20 weight percent of the final nut butter product. In another and/or alternative non-limiting specific formulation of this aspect, the sweetener supplement constitutes about 0-20 weight percent of the final nut butter product, typically about 1-10 weight percent of the final nut butter product, and more typically about 3-9 weight percent of the final nut butter product. In still another and/or alternative non-limiting specific formulation of this aspect, the salt supplement constitutes about 0-5 weight percent of the final nut butter product, typically about 0.1-2 weight percent of the final nut butter product, and more typically about 0.5-1.2 weight percent of the final nut butter product. In yet another and/or alternative non-limiting specific formulation of this aspect, the flavoring agent supplement constitutes about 0-5 weight percent of the final nut butter product, typically about 0.05-2 weight percent of the final nut butter product, and more typically about 0.05-0.8 weight percent of the final nut butter product.

In yet another and/or alternative aspect of the present invention, the improved nut butter is used as the center filling of a sandwich, such as a peanut butter and jelly sandwich. In one embodiment, the sandwich is a crustless sandwich having a high quality peripheral seal. In one aspect of this embodiment, the sandwich can be stored for long periods of time without a central filling leaking outwardly. The proportion of jelly to nut butter on the sandwich is not limited. The tendency of the jelly to leach from the center filling is significantly reduced or eliminated. In another and/or alternative embodiment of the invention, the invention allows for the mass production of a crustless sandwich having a composite center filling, wherein the center filling does not drastically decrease or affect the appearance of the product during long term storage required in retail distribution. For purposes of this invention, the nut butter can be referred to as the encapsulating food component and the jelly can be referred to as the filling food component. The term nut butter is defined as nut butter made from peanuts and/or from other types of nuts. The term jelly is defined as including jelly, jams, preserves or other fruit spreads. As can be appreciated, the present invention is not limited to the use of jelly as the only filling food component that can be at least partially encapsulated by peanut butter and/or one or more other encapsulating food components. For instance, the following filling food components can be used in combination with or an alternative to jelly, namely, honey; butter; pudding; apple butter; fruit puree and/or other fruit fillings other than jelly; syrup; chocolate syrup; cheese whip, hummus, chickpea paste, refried beans, cream cheese and/or other cheese filling; whipped cream and/or other cream fillings; marshmallow filling; and/or yogurt. The encapsulating food component generally has an average consistency or viscosity at room temperature (i.e. 20-24° C.) that is greater than the average consistency or viscosity of one or more of the filling food components. In another and/or alternative embodiment, the filling food component constitutes by weight at least about 5% of the total weight of the filling food component plus the encapsulating food component, and typically at least about 10%, more typically at least about 20%, even more typically at least about 25%, and still even more typically at least about 30%.

In still yet another and/or alternative aspect of the invention, there is provided an apparatus and method for at least partially encapsulating a filling of a sandwich from two thin slices of baked bread having outer crust. As can be appreciated, the sandwich can be made from two thin slices of baked bread that do or do not have an outer crust. “Thin” as defined herein means less than about one inch. In one aspect of this embodiment of the invention, one method of the invention involves placing a first slice of the bread on a platen having a center portion and a pressure surface surrounding the central portion. This surface encompasses a closed given shape, such as a circle, a square, or a rectangle; however, other shapes can be used. In practice, the pressure surface is also the cutting surface for a knife or cutter defining the given shape of the sandwich. With the first slice of bread on the platen, a mass of a first food spread (e.g. nut butter) is formed onto the first slice above the center portion of the platen. Typically, the first food spread is spaced inwardly from the pressure surface of the lower support platen. In one aspect of this embodiment, the first food spread is applied to the first slice of bread in a substantially uniform thickness. In another and/or alternative aspect of this embodiment, the first food spread is formed with an inner lower layer having an outer rim extending upwardly from the lower layer. As such, the rim defines a closed receptacle or recess for the first food spread. In one non-limiting design, the rim has an average height of at least about 0.1 inch, and typically at least about 0.125 inch, and more typically about 0.125-0.5 inch. In one particular non-limiting formulation, the first food spread is a highly viscous peanut butter having a relatively low water activity, such as below 0.70. With this low water activity, the first food spread when contacting first slice of bread will not cause sogginess of the bread. The method further involves placing a second food spread onto the first food spread. In one aspect of this embodiment, the second food spread is placed on the first food spread such that the second food spread is spaced from the outer peripheral edge of the first spread. Typically, the second food spread is spaced from all regions of the outer peripheral edge of the first spread. If the first food spread includes an inner lower layer having an outer rim extending upwardly from the lower layer, the second food spread is positioned on the inner lower layer such that the second food spread substantially does not overflow from the outer rim of the first food spread. In one specific non-limiting formulation, the second food spread is jelly. Typically, the jelly has a lower viscosity than the first food spread, thus it tends to flow outwardly on the first food spread. When the first food spread includes an outer rim, the outer rim inhibits or prevents the jelly from spreading outwardly over the edge of the peanut butter layer. As such, the receptacle or recess can be as deep and as transversely large as necessary to accommodate the desired amount of jelly without concern of the jelly contacting the first slice of bread. When the first food spread does not include a receptacle or recess, the amount of jelly applied to the top of the first food spread is selected so that the jelly does not spread outwardly over the edge of the peanut butter layer. The method further involves applying another layer of the first food spread over the second food spread to thereby substantially encapsulate the second food spread between the two layers of first food spread. Typically, the second layer of first food spread typically has the same composition as the first layer of first food spread; however, the second layer can have a different composition (e.g. cream filling). The first and second layer of first food spread typically have a water activity that is less than the water activity of the second food layer; however, this may not always be the case. The first and second layer of first food spread typically have a viscosity that is greater than the viscosity of the second food layer; however, this may not always be the case. When the second layer of first food spread is applied over the second food spread that is at least mostly contained in the receptacle or recess of the first layer of first food spread, the receptacle or recess is substantially closed by the second layer of the first food spread. As such, a covering layer of first food spread is placed over the recess and in contact with the upstanding rim dividing the recess. The method further involves a second layer of bread being placed over the second layer of first food spread. The application of the second layer of bread to the second layer of first food spread causes the second or upper layer of first food spread into sealing relationship with the first or lower layer of first food spread, thus positively encapsulating the deposited second food spread to produce a substantially sealed composite food layer. In one particular non-limiting arrangement, the first and second layer of first food spread is peanut butter and the second food spread is jelly. By substantially encapsulating the second food spread between the first and second layers of first food spread, only the low water activity first food spread contacts the bread, thus preventing the bread from becoming soggy. The second food spread, which typically has a water activity that is greater than 0.60 substantially does not contact the bread. Contact of a high water activity second food spread with the bread would have serious implications for long storage of the product as necessary for hermetically sealed sandwiches stored in freezers and/or on shelves. The invention involves the substantial or complete encapsulation of the second food spread between two layers of the first food spread. If the first layer of the first food spread includes a receptacle or recess, there is substantial or complete encapsulation of the second food spread in a precise receptacle formed by the first food spread.

In still another and/or alternative aspect of the present invention, there is provided an apparatus and method for making a crustless sandwich. After forming the encapsulated composite food layer spaced inwardly from the marginal areas of the two slices of bread, the bread slices are cut in unison in a cut pattern to remove the crust from both bread slices. In practice, the cut of the bread is by a knife or cutter acting against a flat surface encompassing the pressure surface. The cut pattern is the closed given shape of the sandwich. After the crust has been removed from the two slices of bread, the outer periphery of the sandwich is at least partially sealed. As can be appreciated, the sandwich can be formed from crustless slices of bread. When crustless slices of bread are used, the cutting of the sandwich is not required. However, the sandwich may still be cut to form the desired shape of the sandwich. In one embodiment of the invention, after the bread has been cut, a pressure is exerted around the periphery of the cut bread pieces and against the pressure surface of the platen to at least partially crimp the slices into a crustless sandwich at large marginal areas to thereby at least partially seal the outer periphery of the sandwich. This crimped area has a thickness that is generally greater than about 0.05 inch, typically greater than about 0.1 inch, more typically greater than about 0.20 inch, and even more typically about 0.25-0.75 inch. This surface has a generally constant pressure gradient and not the decreasing pressure gradient of a pinch action as suggested in Sollerud 3,782,270. By first cutting the bread and then crimping the bread at a large flat marginal area surrounding the center filling, the crimping action is not dependent upon the cutting action and is substantially uniform through the width of the marginal area. In addition, there is no squeezing or pinching action which can cause a very thin interface between the two slices. Furthermore, the substantial absence of a squeezing or pinching action substantially reduces tearing and/or other damage to one or both of the bread slices. Thus, the method of the invention involves the technique disclosed in Kretchman 6,004,596, which is incorporated herein by reference. Use of this method for the making of a crustless sandwich inhibits or prevents undesired seepage from the composite food layer into the bread pieces, which seepage can adversely affect certain portions of the crimped periphery of the crustless sandwich. In another and/or alternative embodiment of the invention, the platen defines an outer edge to coact with a cutter in a scissor cutting action.

In yet another and/or alternative aspect of the present invention, the central portion of the platen supporting the first spread slice includes a recess. This recess is typically a concave structure especially when the sandwich is circular; however, other shapes of the recess and/or shape of the sandwich to be formed can be used. This recess portion generally is shallow, but is deep enough to allow the bread pieces to be crimped without exposing the bread slices to undue pressure in and about the central portion of the sandwich when the sandwich is being cut and/or crimped. In one embodiment of the invention, the upper peripheral surface at least partially about the recess is substantially flat to define the cutting surface and/or the crimping surface; however, other shapes can be used.

In still yet another and/or alternative aspect of the invention, a pressure plate is used to at least partially facilitate in the crimping action at the periphery of the sandwich. In one embodiment of the invention, the pressure plate includes a lower pressure surface positioned at least partially above at least a portion of the pressure surface of the sandwich supporting platen. In one aspect of this embodiment, the lower pressure surface includes spaced projections to create depressions in at least the top slice of bread to form spaced pressure points in the crimped slices. In one non-limiting design, the projections are undulations in the pressure surface or a series of spaced rectangular projections; however, other shaped surfaces can be used. The pressure surface on the platen is generally flat. Typically, the pressure surface on the platen also defines the cutting surface of the bread when the slices of bread are cut. As can be appreciated, the pressure surface on the platen can include spaced projections to create depressions in at least the bottom slice of bread to form spaced pressure points in the crimped slices.

In a further and/or alternative aspect of the present invention, the upwardly facing pressure surface of the platen has projections, which may or may not match one or more projections, if used, on the pressure plate. Various arrangements and modifications of the pressure plate and the pressure surface of the platen can be made to enhance the precise crimping action between the outer flat surfaces of the bread pieces. In one embodiment of the invention, the bread slices can be cut like a cookie cutter against a flat surface or by a scissor cutting action with an edge on the platen. This cutting action is at least partially prior to the crimping action. As such, crimping is a separate and distinct process which can be optimized by modifying the crimping surfaces which are relatively broad and encompass a substantial marginal area of the sandwich being produced. The width of the crimped marginal areas of the bread pieces is at least about 0.05 inches. Typically, the crimped area is at least about 0.20 inches in width. This gives a general constant force gradient over the flat marginal area. This crimped region is significantly different from and superior to a squeezed or pinched separation seam.

In still a further and/or alternative aspect of the present invention, there is provided an apparatus for making a crustless sandwich from two slices of bread. This apparatus comprises a device to place a first slice of bread on a platen with a center portion and a pressure surface surrounding the central portion encompassing a closed given shape. In one embodiment of the invention, the pressure surface is a substantially flat surface. If the pressure surface is used to at least partially cut the one or more slices of bread, the cutting action can be used to remove the crust of bread having a crust and/or to form an outer peripheral shape for the sandwich. In another and/or alternative embodiment of the invention, a dispenser deposits a mass of a first food spread onto the first slice of bread above the central portion of the platen and spaced inwardly from the pressure surface of the platen. The central portion of the platen can be substantially flat or include a recessed portion. In one aspect of this embodiment, the first food spread has a substantially uniform thickness. In another and/or alternative aspect of this embodiment, the first food spread includes an outer rim having an average height of at least about 0.10 inches. The formed rim extends upwardly from the lower layer to define a receptacle recess in the first food spread. In still another and/or alternative aspect of this embodiment, a device is used to place a second food spread onto the first food spread on the first slice of bread. The second food spread is placed on the first food spread so that substantially all of the second food spread is spaced from the peripheral edge of the first food spread. When the first food spread includes a rimmed region, substantially all of the second food spread is placed within the rimmed region. After the second food spread has been inserted in the first food spread, a second dispenser then applies a layer of the first food spread generally coextensive with the first food spread on the first slice of bread. As such, the peripheral edges of the two layers of first food spread are generally coextensive and thereby form a pocket for the second food spread. When the first layer of first food spread includes a rim, the second layer of first food spread is generally supported on the rim. This allows the first food spread to encapsulate the second food spread, thus forming a center composite food layer. This constitutes a novel feature of the invention. To complete the sandwich, a second bread slice is placed over the first slice. Then, the two slices are cut, if desired, into a defined shape. The cut can be with a cookie cutter or a scissor cutter or other type of cutter. The outer periphery of the bread slices is crimped at the peripheral flat marginal areas. The crimping action is by a force gradient generally constant over the marginal areas. This allows optimization of the crimping action as taught by Kretchman 6,004,596.

In still yet a further and/or alternative aspect of the present invention, a crustless sandwich is made from two slices of baked bread that includes an outer crust. The sandwich comprises first and second matching crustless bread pieces cut from the crusted bread slices. The bread pieces have the same general outer shape defined by an outer periphery with central portions surrounding the flat outer marginal areas to provide facing bread surfaces at the central portions of the slices. A composite food layer is provided between the central portions of the slices and is spaced inwardly from the flat marginal areas of the slices. The composite food layer includes a mass of a first layer of first food spread applied to a first slice of crust bread. The first layer of first food spread may or may not include a lower layer with an upstanding rim to define a closed receptacle recess or pocket. A second food layer is applied to the first layer of first food spread and is then covered by a layer of the first food spread to at least partially encapsulate the second food spread. As can be appreciated, when the first layer of first food spread includes a rim, the quantity of second food spread applied to the first layer of first food spread is not limited by the quantity of first food spread applied to the first slice of bread. The second food spread is at least partially held between the two layers of first food spread prior to, during, and after subsequent cutting and/or crimping of two slices of bread. This crustless sandwich has the advantages discussed with respect to the method of making the sandwich.

The primary object of the present invention is the provision of a method and apparatus for making a nutritional sandwich.

Another and/or alternative object of the present invention is the provision of a method and apparatus for making a nutritional sandwich that includes a nutritionally enhanced nut butter.

Still another and/or alternative object of the present invention is the provision of a method and apparatus for enhancing the nutritional valve of nut butter for use in a sandwich.

Yet another and/or alternative object of the present invention is the provision of a method and apparatus for making a crustless sandwich, which method and apparatus combines the advantageous processing procedure in Kretchman 6,004,596.

Still yet another and/or alternative object of the present invention is the provision of a method and apparatus for making a sandwich, which method and apparatus controls the placement of the portions of two food spreads between the bread pieces, where the spreads are a composite layer in the sandwich.

A further and/or alternative object of the present invention is the provision of a method and apparatus for making a sandwich, which method and apparatus inhibits or prevents the spreading of the center food spread from two encapsulating layers of bread contacting food spread.

Still a further and/or alternative object of the present invention is the provision of a method and apparatus for making a sandwich, which method and apparatus includes the use of one food spread that inhibits or prevents the leaching of an inner food spread under the pressure of the crimping action or by mere migration.

Yet a further and/or alternative object of the present invention is the provision of a method and apparatus which allows the positive encapsulation of jelly in nut butter so that jelly does not engage the bread.

Still yet a further and/or alternative object of the present invention is the provision of a method and apparatus which allows the optimization of the proportion of peanut butter and jelly in a sandwich, without the disadvantage of unwanted leaching or the need to reduce the size of the flat marginal crimping surfaces.

Another and/or alternative object of the present invention is the provision of a sandwich which can be hermetically packaged and used for retail distribution with quantity control of the filling and prevention of unwanted contact between one food spread and the bread.

Still another and/or alternative object of the present invention is to provide a sealed sandwich that does not have a crust.

Yet another and/or alternative object of the present invention is to provide a sealed crustless sandwich that substantially retains an inner filling from seeping into the bread portion.

Still yet another and/or alternative object of the present invention is to provide a sealed crustless sandwich that can be stored for extended periods of time.

These and other objects and advantages will become apparent from the discussion of the distinction between the invention and the prior art and when considering the preferred embodiment as shown in the accompanying drawings.

### BRIEF DESCRIPTION OF DRAWINGS

FIG. 1 is a pictorial view partially cross-sectioned of a crustless sandwich made with one embodiment of the invention;

FIG. 1A is a view of a cross-sectioned crustless sandwich made with another embodiment of the invention;

FIG. 2 is a top plan view taken through the crustless sandwich at the stage of manufacturing shown in FIG. 5 with a cut-away view showing a portion of the lower support platen;

FIGS. 3-5 are a series of cross-sectional views at progressive operations in the manufacturing of the crustless sandwich using an alternative cutting action and crimping action;

FIG. 4A is a modification of FIG. 4 illustrating a platen that does not have a recess;

FIG. 6 illustrates a process flow chart for modifying the nutritional value of an existing peanut butter for immediate or later inclusion in a sandwich;

FIG. 7 is a schematic side elevational view illustrating a dispenser for practicing one embodiment of the present invention;

FIGS. 7A-7D are schematic side elevational views illustrating alternative dispensers for practicing other embodiments of the present invention;

FIG. 8 is a cross-sectional view of the cutting method and apparatus for completing a sandwich using the invention;

FIG. 8A is a cross-sectional view of the cutting method and alternative apparatus for completing a sandwich using the invention; and,

FIG. 9 is a cross-sectional view of the apparatus shown in FIG. 8 illustrating the crimping method and apparatus for completing a sandwich formed by practicing the present invention.

### PREFERRED EMBODIMENTS OF THE INVENTION

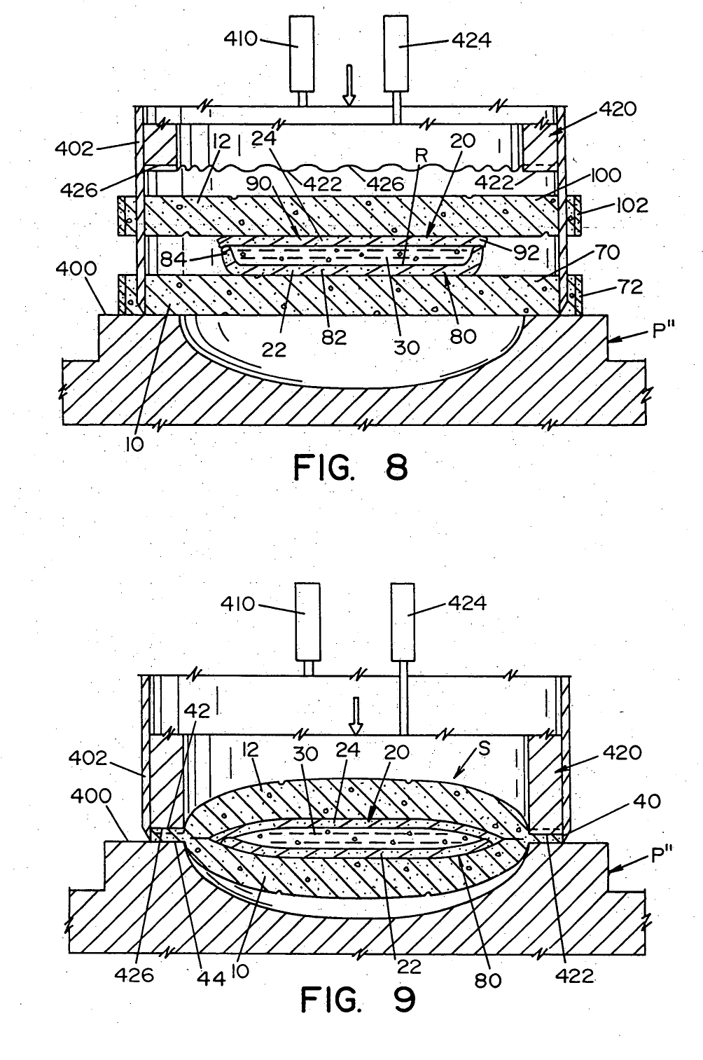

Referring now to the drawings wherein the showings are for the purpose of illustrating the preferred embodiments only and not for the purpose of limiting same, FIG. 1 shows a crustless sandwich S manufactured by the method and apparatus of the invention and constituting an aspect of the invention. This sandwich has a first piece 10 of bread cut from a first crusted slice and a second piece 12 of bread cut from a second crusted slice. These bread slices are typically freshly baked and are white bread made from batter known in the art for providing a sealing action when pressed together at an elevated pressure. As can be appreciated, the bread can be other than white bread. As illustrated, the sandwich is circular; however, in accordance with the invention it can be rectangular, triangular, oblong or other shapes without departing from the concept of the invention. Sandwich S includes a central composite food layer 20 interior of the flat crimped marginal areas and formed from a first deposit 22 of the first food spread which, in practice, is typically nut butter such as, but not limited to, peanut butter. A second deposit 24 of this same first food spread encapsulates a central filling of a second food spread, which in practice is known to the consumer as “jelly”; however, the food spreads of deposits 22, 24 and filling 30 can be other than nut butter or jelly. The water activity of the first food spread is low and is generally less than about 0.60, whereas the second food spread of the filling can have a variety of low or high water activities. In practice, the second food spread has a water activity of greater than 0.60. These water activities are representative in nature and are selected so that the first food spread will not cause pieces 10, 12 to become soggy during long term shelf storage. Since the first food spread encapsulates filling 30, the filling can have higher water activity without contacting the bread to cause deleterious imperfections which are not tolerable in mass produced sandwiches for retail distribution. Periphery 40 is the cut profile or shape for each bread piece 10, 12 and is outside the generally flat marginal areas 42, 44. These areas have a flat width of at least about 0.10 inch. The marginal areas substantially do not contain food spread or other substances and constitute the crimping areas of bread-to-bread contact over a large sealing area. In the embodiment of the invention shown in FIG. 1, the crimping is accomplished by undulating surfaces to provide undulations 46, 48 producing pressure points 50 that the high points of the undulations that match each other and cause high pressure exertion at aligned locations around periphery 40 of sandwich S. In practice, there are no undulations on the under surface which is formed by a generally flat anvil surface. This surface is laterally extended to give a cookie cutter surface as shown in FIG. 8.

Referring now to FIG. 1A, another crustless sandwich S is manufactured by the method and apparatus of the invention and constitutes another aspect of the invention. This sandwich has a first piece 10 of bread cut from a crusted slice and a second piece 12 of bread cut from a second crusted slice. These bread slices are typically freshly baked and are white bread. As can be appreciated, the bread can be other than white bread. The sandwich is generally circular; however, it can be rectangular, triangular, oblong or other shapes without departing from the concept of the invention. Sandwich S includes a central composite food layer 20 interior of the flat crimped marginal areas and formed from a first deposit 22 of the first food spread which, in practice, is typically nut butter such as, but not limited to, peanut butter. A second deposit 24 of this same first food spread encapsulates a central filling of a second food spread. The water activity of the first food spread is generally less than about 0.60, whereas the second food spread of the filling can have a variety of low or high water activities. In practice, the second food spread has a water activity of greater than 0.60. Periphery 40 is the cut profile or shape for each bread piece 10, 12 and is outside the generally flat marginal areas 42, 44. These areas have a general width of at least about 0.10 inch. The marginal areas substantially do not contain food spread or other substances and constitute the crimping areas of bread-to-bread contact over a large sealing area. In the embodiment of the invention shown in FIG. 1, the crimping is accomplished by compression between two substantially flat surfaces. The central composite food layer 20 is illustrated as having a generally flat bottom surface and a dome-shaped top surface. As illustrated in FIG. 1, central composite food layer 20 is illustrated as having a bottom and a top dome-shape. The differences in the shapes of the central composite food layer is a result of the shape of the platen P as will be described in more detail below.

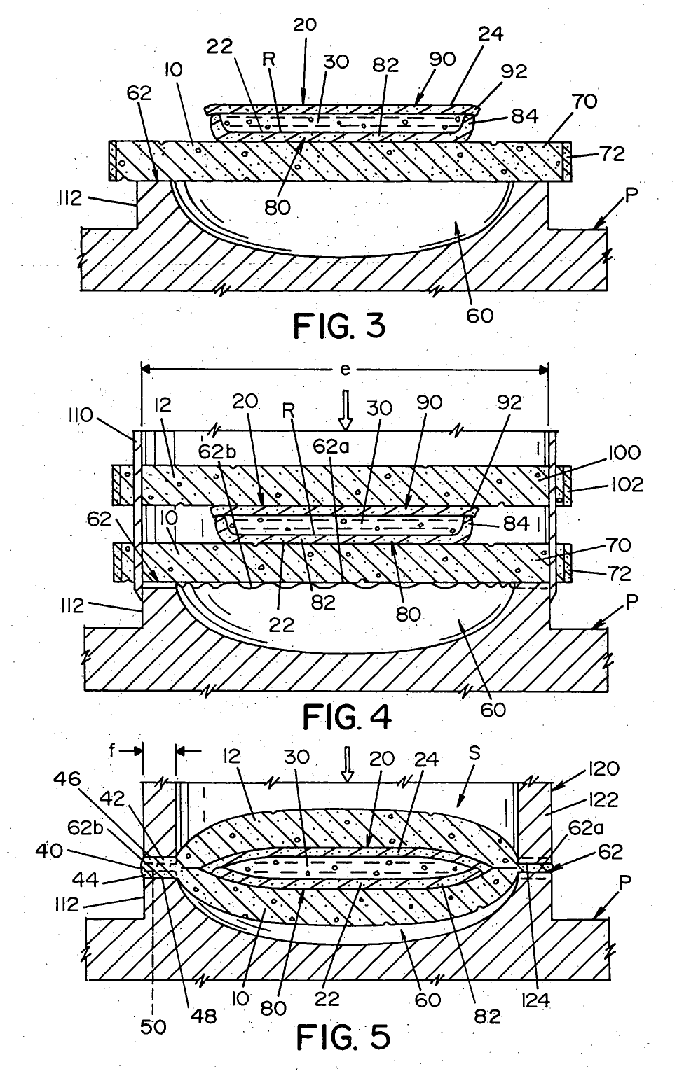

The acts performed to produce crustless sandwich S are disclosed in FIGS. 3-5. In any variations of these process operations or acts can be used to accomplish the objective of producing a crustless sandwich which has a flat area sealed periphery using the disclosed technology. Features from the several apparatuses can be combined to perform the production process of the claimed invention. Thus, the cutting techniques and the crimping techniques can be combined to produce a magnitude of apparatuses.

In accordance with the invention, the quantity and proportion of filling 20 is controlled without experiencing a squeezing of the filling into the bread or the crimped marginal areas during assembly of the sandwich. In the illustrated embodiments of FIGS. 3-5, a platen P, which can be stationary or movable, is used to receive the assembled components of the crustless sandwich. Platen P can be movable to allow each of the process acts to be performed at different locations in an assembly line without requiring movement of the partially assembled sandwich components. In one aspect of the invention, the central portion 60 of platen P is recessed as illustrated in FIGS. 3-5. In another aspect of the invention, central portion 60 of platen P does not include a recess as illustrated in FIG. 4A. Since the illustrated embodiment of the sandwich shown FIG. 1 is a circular sandwich, a somewhat common recess has a concave configuration of central portion 60 as shown in FIGS. 3-5. As can be appreciated, other shaped sandwiches can be formed on platen P, thus the shape of the recess on the central portion can be designed to accommodate such shapes.

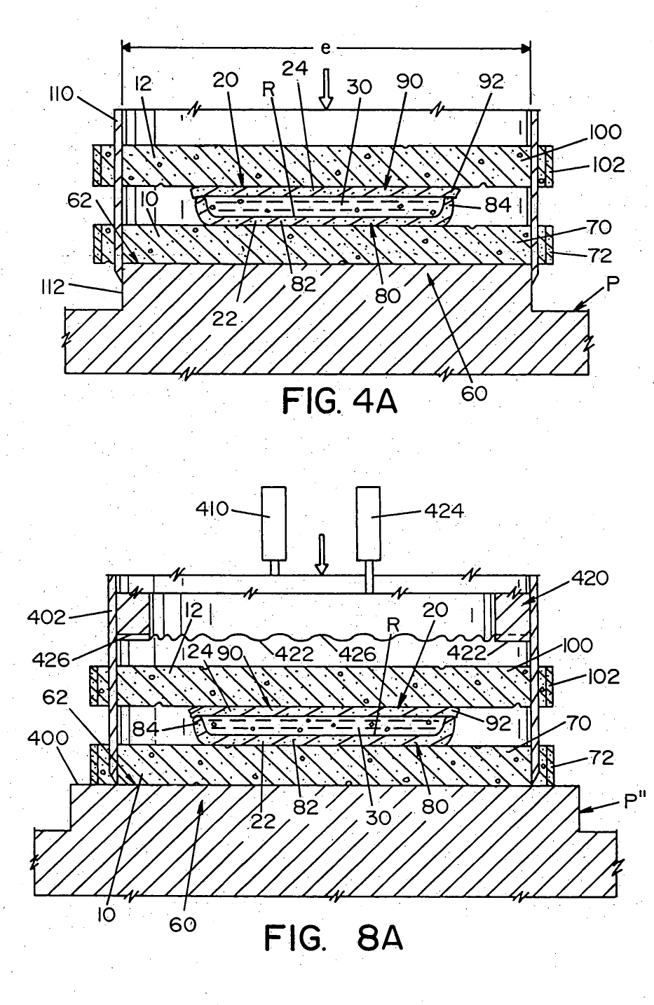

This platen includes upwardly facing pressure surface 62 which is typically flat as shown in FIGS. 3, 4A and 8A. As illustrated in FIGS. 4 and 5, and alternative surface of platen P is illustrated. As shown in FIGS. 8, 8A and 9, the crimping support surface extends laterally to define the cutting surface of a cookie cutter. All of these concepts are used in appropriate combination to practice the invention. In the alternative concept, undulations are on the pressure surface. The undulations define high points 62a and low points 62b to give spaced projections formed by the high points 62a as illustrated in FIGS. 4 and 5.

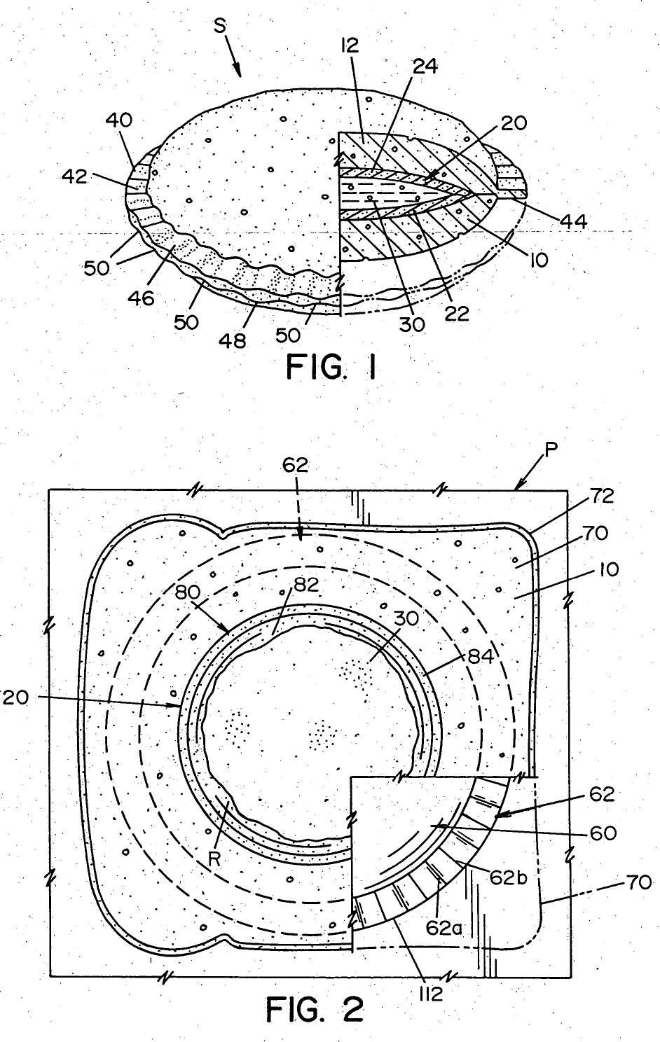

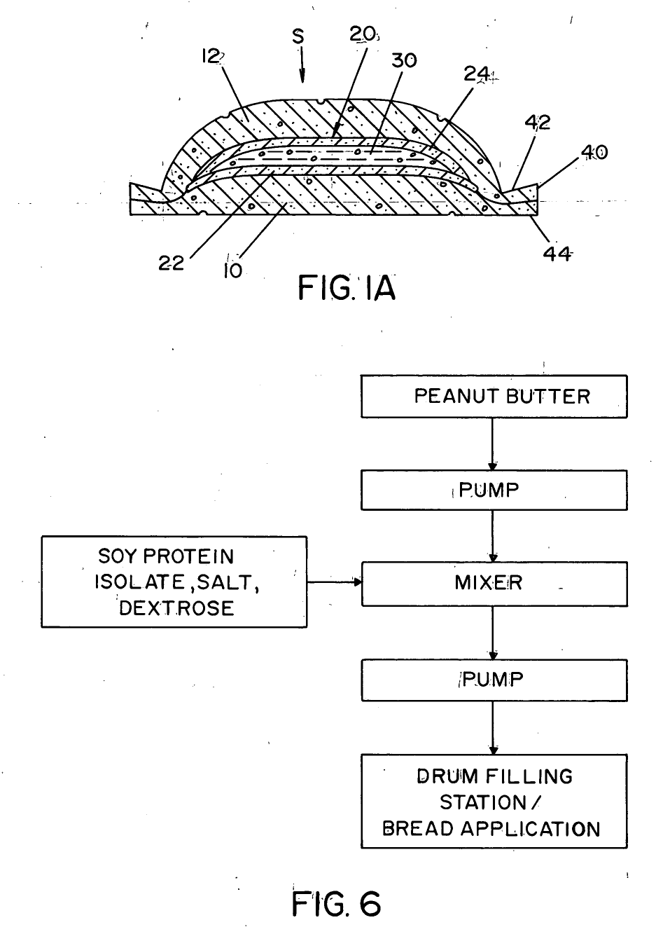

As shown in FIG. 3, a first slice of bread 70 having a thickness of less than about ¾-inch and an outer crust 72 is placed over platen P and aligned with central portion 60 so that pressure surface 62 is within the crust, as best shown in FIG. 2. The bread slices are typically in the range of ½-¾ inch in thickness to control the bread component of the sandwich. A mass 80 of a first food spread, typically nut butter, produces the first deposit 22 of composite food layer 20. This formed mass includes a thin inner lower layer 82 with a thickness to assure no lower holes and a peripherally extending rim 84 to define a central filling receiving receptacle, pocket, or cavity R. The rim has a height of at least about 0.10 inch. The volume of receptacle R is controlled by the exposed area of thin lower layer 82 and the extended height of peripheral rim 84. Consequently, the volume of the receptacle is controlled to receive the desired amount of filling 30. In this manner, larger proportions of jelly to peanut butter can be provided in sandwich S without risking jelly to bread contact and its long term deleterious effect. FIG. 2 is a cross section of the assembled sandwich as it has progressed to the operation illustrated in FIG. 5. One inventive aspect of the present invention is completed by the operation as illustrated in FIG. 5, wherein upper layer or cap 90 is deposited to cover filling 30 and close receptacle R by overlying rim 84. This produces a second deposition 24 of composite food layer 20. Layer 90 has outer edge 92 to cover receptacle R. The edge has a shape determined by the shape of receptacle R, which in one embodiment is circular, to encapsulate filling 30 in receptacle R. As illustrated in FIG. 1A, the composite food layer 20 does not includes a first deposit 22 that includes a peripheral rim 84. As such, when filling 30 is positioned on first deposit 22, the amount of filling 30 is selected such that the filling does not run off or overflow off the peripheral edge of the first deposit. The second deposit 24 is then applied over filling 30 and first deposit 22, thereby forming composite food layer 20.

A second thin slice 100 of a bread having an outer crust 102 is placed in general alignment with slice 70 over composite food layer 20 as illustrated in FIGS. 4 and 4A. As illustrated in FIGS. 4 and 5, the composite food layer 20 is aligned with recess 60 and spaced inwardly from pressure surface 62. Pressure surface 62, as illustrated in FIGS. 4 and 4A is generally aligned with marginal areas 42, 44 of the slices of crusted bread. As illustrated in FIGS. 4 and 4A, slices 70 and 100 are cut to produce the matching pieces 10, 12 with a diameter e. The cutting of the bread slices together assures that the pieces match in shape and remain aligned on platen P. The shape of periphery 40 is determined by knife or cutter 110 coacting in a scissor action with cutting surface 112 of platen P for providing the crustless sandwich with outer marginal areas not yet joined. This scissor action is an alternative to a cookie cutter type cutting shown in FIGS. 8 and 8A. The marginal areas 42, 44 have a width that is at least partially determined by surface 62. In practice, this width is at least about 0.10 inch and in the general range of 0.20-0.50 inches.

In FIG. 5, a crimper 120 is used to crimp together the ends of the two slices of bread. The crimper can be in the shape of a cylinder; however, other shapes can be used. The crimper can be designed to be slidably received in cutter 110; however, it can be separate from the cutter. By reciprocating crimper 120 in cutter 110, the shape of periphery is closely matched with the crimping action of crimper 120. The crimper includes a wall 122 having a lower surface 124 which can be flat as shown in FIG. 5; however, other shapes can be used. This flat wall can include protrusions to create pressure points; however, the flat wall does not require such protrusions. Lower surface 124 acts against a lower flat wall that does not have protrusions as illustrated in FIGS. 3, 4A, 5, 8, 8A and 9; however, the lower wall can have protrusions as illustrated in FIG. 4. An upper flat surface without undulations is typically used when low support surface 62 has undulations as illustrated in FIG. 4. If surface 62 is flat, then lower surface 124 typically has spaced projections illustrated as alternating undulations with high points and low points. If both the pressure surface 62 and lower crimping surface 124 are undulating, typically the high points of the undulations match to produce the configuration shown schematically in FIG. 1. In practice, spaced high pressure points are used to assure a positive crimping interaction between the slices 10, 12. Various projections and combinations of projections can be used for this purpose. In practice, the projections shown in Kretchman 6,004,596 are employed with the projections being spaced inwardly from periphery 40 to create high pressure points spaced inward from the outer periphery 40 a small distance to form a sandwich as illustrated in FIG. 1A. In practice, this inward spacing distance is approximately about 1/16-⅛ inches. The pressure points can extend to periphery 40; however, they are typically spaced inwardly from periphery 40. Crimper 120 as shown in FIGS. 5 and 9 matches the pressure surface 62 to crimp marginal areas 42, 44 at locations outward from the central composite food layer 20.

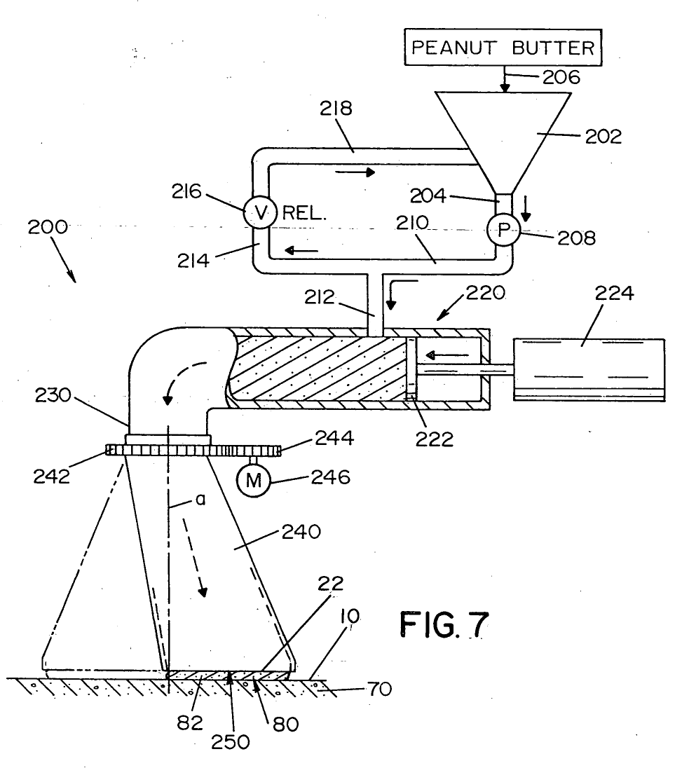

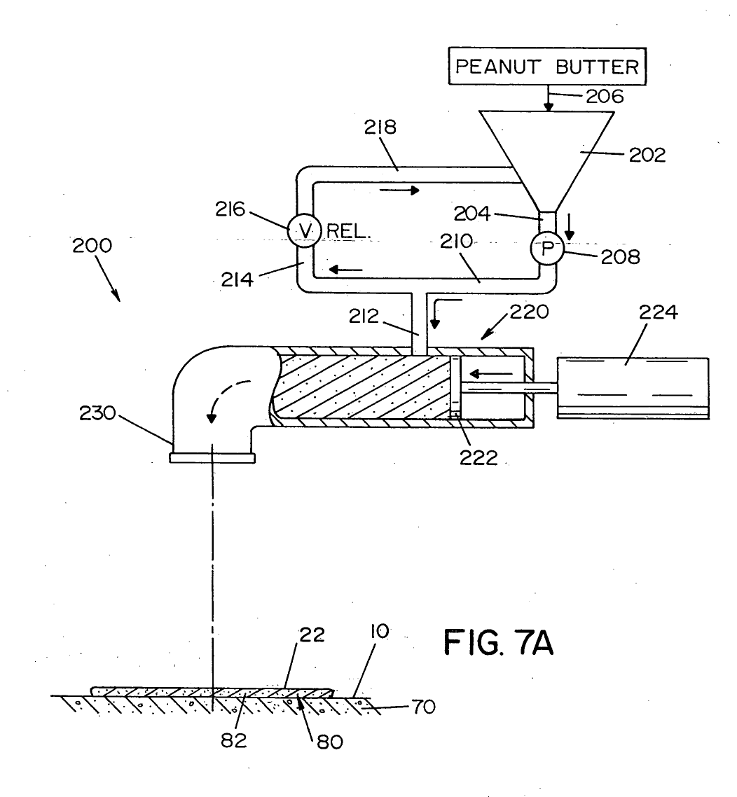

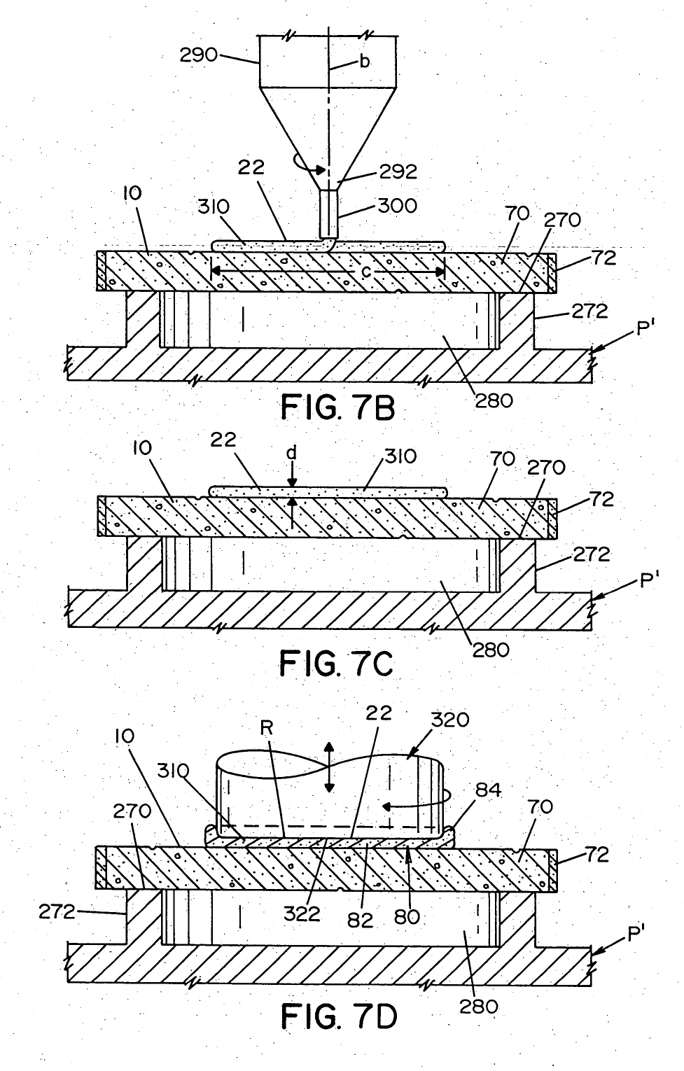

A variety of dispensers can be used for depositing formed mass 80 onto slice 70 to provide an upwardly facing receptacle R as illustrated in FIGS. 3, 4, 4A, 8 and 8A. One embodiment is illustrated in FIG. 7, showing dispenser system 200 having a hopper 202 for receiving a first food spread such as nut butter having a viscosity in the general range of about 4000-10000 centipoise and typically above about 6000 centipoise. The first food spread has a water activity that is typically less than about 0.60 to inhibit or prevent water leaching into bread slice 70. Hopper 202 has an outlet feed pipe 204 and is supplied with the first food spread at inlet 206. Pump 208 forces the first food spread into pipe 210 with outlet 212. Return line 214 includes pressure relief valve 216 for returning the first food spread through pipe 218 back to hopper 202. Thus, fresh pressurized first food spread is available at outlet 212. A dispensing feed ram unit 220 is communicated with feed outlet 212 to receive the first food spread in sufficient quantities to deposit the desired amount of the first food spread to form mass 80. Piston 222 is reciprocated by drive device 224 having a stroke for each reciprocation to deposit the desired amount of the first food spread in mass 80. The first food spread is directed through chute 230 into a thin spout 240 rotated about axis a by a drive gear 242 rotated through pinion gear 244 driven by stepping motor 246. As each slice of bread is moved by platen P under dispenser system 200, step motor 246 rotates thin outwardly extending spout 240 through an angle of over about 360°. In practice, the rotation is through an angle of 370°. Axis a is generally centered with respect to pressure surface 62 of platen P. During this rotation, piston 222 is cycled by a stroke forcing a desired amount of the first food spread through outlet opening 250 onto slice 70. Nozzle 250 at the outlet end of thin spout 240 has a relatively narrow leg terminating in a radially outward large volume dispensing opening. The trailing edge of spout 240 can include a rim shaping mouth intersecting the opening. As a large volume of the first food spread is dispensed through the opening, it is shaped by the contour of the rim shaping mouth to produce rim 84 of mass 80. As drive device 224 squeezes the first food spread though nozzle 250, the nozzle is rotated about axis a by motor 246 through an angle of 370°. Nozzle 250 of spout 240 is spaced above bread 70 a distance to clear or set the thickness of layer 82. This is one dispensing system that can be used in practicing the invention to produce the desired form mass of the first food spread to receive the desired amount of the second food spread such as jelly or filling 30 as so far described. Several arrangements can be used to provide pressurized first food spread at the dispensing spout. The spout can also have many mechanical versions.

An alternative mechanism for forming mass 80 is illustrated in FIG. 7A. In this mechanism, the formed food mass does not include a rim. The mechanism is similar to FIG. 7 except that there is no spout 240 or a motor that rotates spout 240. In this configuration, the first food spread is directed through chute 230 onto bread 70.

Still another alternative mechanism for forming mass 80 with a lower layer 82 and rim 84 is schematically illustrated in FIGS. 7B-7D. A movable platen P′ includes an upwardly facing, lower flat pressure surface 270 circumscribed by cutting edge 272. In practice, surface 270 is extended laterally to give a cutting surface as shown in FIGS. 8 and 9. Slice 70 is deposited upon platen P′ above recess 280 in a manner and for the reasons previously discussed. As can be appreciated, the platen may not include a recess as discussed above. A pressurized peanut butter hopper 290 similar to the hopper in FIGS. 7 and 7A includes a downwardly extending feed pipe 292 directing the first food spread to an elongated rotating spout 300. System 200 shown in FIGS. 7 and 7A can be used to pressurize the first food spread. A dispenser piston and rotating mechanism as in FIGS. 7 and 7A can be used. Spout 300 is rotated about axis b and includes at least one and typically two or more outboard legs with thin openings extending from axis b and each having a length. When two openings are used, the openings have a length of approximately ½ diameter c of circular deposit 310. Feed ram unit 220 forces the first food spread into the circular deposit 310 to a depth indicated as thickness d. Thereafter, as shown in FIG. 7D, forming plug 320 is typically heated and rotated fairly rapidly. The plug includes a contoured end 322 movable into deposit 310 to force the first food spread into the upstanding rim 84 while leaving a thin lower layer 82. This produces a receptacle or pocket R for the purposes previously described. This gives one of several alternative procedures to produce the pocket R. As can be appreciated, the use of the forming plug can be eliminated to form a first food spread which does not have a rim.

The present invention also pertains to enhancing the nutritional value of sandwich S. In one embodiment, the nutritional value of the first food spread is enhanced prior to the first food spread being inserted into hopper 202. As stated above, the first food spread is typically a nut butter such as peanut butter. When nut butter is used as the first food spread, the nutritional value of the nut butter can be enhanced by adding vitamins, minerals, protein and/or fiber to the nut butter. These nutritional enhancers can be added during the manufacture of the peanut butter. For instance, one or more nutritional enhancers can be added to the nut while the nuts are being ground into nut butter. Alternatively or additionally, one or more nutritional enhancers can be added to the ground nuts and mixed with the ground nuts along with other components of the nut butter such as sweeteners, salt, stabilizers, emulsifiers, flavoring agents, etc. When nutritional enhancers are added to the nut butter, the nut butter is typically considered a specialty product, thus produced in far lesser amounts than regular nut butter and further commanding a premium price due to the low volume of the nut butter and nature of the specialty product. As such, the purchasing of commercially available nutritionally enhanced nut butter for use in manufacturing sandwich S can be cost prohibitive. Furthermore, the selection of nut butter having enhanced nutritional value is limited to the commercially available specialty products. As such, a commercially available nut butter having a certain protein content and/or vitamin content may not be available, thus limiting the nutritional range of the manufactured sandwich. In an effort to overcome this problem to supply a particular nutritionally enhanced first food spread to sandwich S, an existing commercially available first food spread is nutritionally enhanced prior to applying the first food spread onto the bread of the sandwich.

Referring now to FIG. 6, there is illustrated a novel process of nutritionally enhancing a pre-made peanut butter. The first step of this process is to obtain a pre-made peanut butter. The peanut butter is typically a commercially available peanut butter that can be readily obtained in large quantities. The pre-made peanut butter is typically inserted into a holding container or hopper and then pumped or otherwise transported from the holding container or hopper to a mixer. While the pre-made peanut butter is in the mixer, the pre-made peanut butter is mixed with one or more nutritional enhancers. Such enhancers include, but are not limited to, vitamins, minerals, protein and/or fiber. As illustrated in FIG. 6, the nutritional enhancer that is mixed with the pre-made peanut butter is a protein supplement such as a soy protein isolate. As can be appreciated, many other and/or additional protein supplements can be used. As can further be appreciated, additional and/or alternative nutritional enhancers can be used to enhance the nutritional valve of the peanut butter. In addition to the protein supplement, two flavoring agents are also mixed with the pre-made peanut butter. Salt and a sweetener such as dextrose are illustrated as being mixed with the soy protein isolate in the pre-made peanut butter. As can be appreciated, additional and/or alternative flavoring agents can be mixed with the pre-made peanut butter. The flavoring agents are typically selected and added in a quantity to a) at least partially mask the flavor of the one or more added nutritional enhancers, b) modify and/or improve the flavor of the peanut butter, and/or c) modify and/or improved the physical properties of the peanut butter (e.g., viscosity, water activity, color, texture, melting point, etc.). One non-limiting general formula for nutritionally enhanced nut butter comprises:

| | | |
|---|---|---|
| Pre-made nut butter | 60-99 | wt. % |
| Nutritional enhancer(s) | 0.5-40 | wt. % |
| Flavoring agent(s) | 0-25 | wt. % |

A few non-limiting examples include:

### EXAMPLE 1

| | | |
|---|---|---|
| Pre-made peanut butter | 60-99 | wt. % |
| Nutritional enhancer(s) | 0.5-40 | wt. % |
| Flavoring agent(s) | 0-25 | wt. % |

### EXAMPLE 2

| | |
|---|---|
| Pre-made nut butter | 60-99 wt. % |
| Protein Supplement | 0-40 wt. % |
| Vitamin/Mineral | 0-30 wt. % |
| Supplement | |
| Fiber Supplement | 0-25 wt. % |
| Flavoring agent | 0-25 wt. % |

### EXAMPLE 3

| | |
|---|---|
| Pre-made nut butter | 60-99 wt. % |
| Protein Supplement(s) | 1-40 wt. % |
| Vitamin/Mineral | 0-30 wt. % |
| Supplement(s) | |
| Fiber Supplement | 0-20 wt. % |
| Flavoring agent(s) | 0.1-25 wt. % |

### EXAMPLE 4

| | |
|---|---|
| Pre-made nut butter | 70-95 wt. % |
| Protein Supplement | 4-40 wt. % |
| Vitamin/Mineral | 0-20 wt. % |
| Supplement | |
| Fiber Supplement | 0-15 wt. % |
| Flavoring agent | 1-25 wt. % |

### EXAMPLE 5

| | |
|---|---|
| Pre-made nut butter | 70-90 wt. % |
| Protein Supplement(s) | 4-25 wt. % |
| Vitamin/Mineral | 0-15 wt. % |
| Supplement(s) | |
| Fiber Supplement | 0-15 wt. % |
| Flavoring agent(s) | 3-20 wt. % |

### EXAMPLE 6

| | |
|---|---|
| Pre-made nut butter | 70-85 wt. % |
| Protein Supplement(s) | 8-20 wt. % |
| Vitamin/Mineral | 0-15 wt. % |
| Supplement(s) | |
| Fiber Supplement | 0-15 wt. % |
| Flavoring agent(s) | 4-15 wt. % |

### EXAMPLE 7

| | |
|---|---|
| Pre-made nut butter | 70-85 wt. % |
| Protein Isolate | 10-20 wt. % |
| Calcium | 0-10 wt. % |
| Fiber | 0-10 wt. % |
| Salt and Sweetener | 4-15 wt. % |

### EXAMPLE 8

| | | |
|---|---|---|
| Pre-made nut butter | 70-85 | wt. % |
| Protein Isolate | 10-20 | wt. % |
| Calcium | 0-10 | wt. % |
| Fiber Supplement | 0-10 | wt. % |
| Salt | 0.1-3 | wt. % |
| Sweetener | 1-10 | wt. % |

### EXAMPLE 9

| | | |
|---|---|---|
| Pre-made nut butter | 70-85 | wt. % |
| Soy Protein Isolate | 10-20 | wt. % |
| Calcium | 0-10 | wt. % |
| Fiber Supplement | 0-10 | wt. % |
| Sodium Chloride | 0.3-1.5 | wt. % |
| Dextrose | 3-8 | wt. % |

One specific formulation of a nutritionally enhanced peanut butter is set forth below:

| | |
|---|---|
| Pre-made peanut butter | 79.3 wt. % |
| Soy Protein Isolate | 14.4 wt. % |
| Sodium Chloride | 0.8 wt. % |
| Dextrose | 5.5 wt. % |

This nutritionally enhanced peanut butter has a taste and texture that is nearly the same as the pre-made peanut butter when used in sandwich S. A serving size (2 tablespoons) of the nutritionally enhanced peanut butter has about 7.8% fewer calories than a serving size of the pre-made peanut butter. A serving size of the nutritionally enhanced peanut butter also has about 19% less fat than a serving size of the pre-made peanut butter. Furthermore, a serving size of the nutritionally enhanced peanut butter has about 26% more protein than a serving size of the pre-made peanut butter. As such, the use of the nutritionally enhanced peanut butter in sandwich S will significantly increase the nutritional valve of the sandwich and lower the caloric and fat intake during the consumption of the sandwich.

A number of different mixers can be used to mix the pre-made peanut butter with one or more nutritional enhancers and one or more flavoring agents. Typically during the mixing of the pre-made peanut butter with one or more nutritional enhancers and one or more flavoring agents, the pre-made peanut butter is heated prior to and/or during such mixing to facilitate in combining the one or more nutritional enhancers and one or more flavoring agents with the pre-made peanut butter. The heating of the pre-made peanut butter typically reduces the viscosity of the pre-made peanut butter, thus increasing the rate and/or ease of combining the one or more nutritional enhancers and one or more flavoring agents with the pre-made peanut butter. After all the components of the nutritionally enhanced peanut butter have been mixed together, the nutritionally enhanced peanut butter is typically cooled. After the one or more nutritional enhancers and one or more flavoring agents are mixed with the pre-made peanut butter to form the nutritionally enhanced peanut butter, the nutritionally enhanced peanut butter is pumped or otherwise transported to a drum filling facility to package the nutritionally enhanced peanut butter for later insertion in hopper 202. Alternatively, the nutritionally enhanced peanut butter is pumped or otherwise transported directly to hopper 202 for use in sandwich S. As can be appreciated, the nutritionally enhanced peanut butter can form one or both layers of the first spread of sandwich S, and/or be mixed prior to and/or in hopper 202 with one or more other peanut butters.

As so far disclosed, the sandwich making apparatus can have many designs. The lower pressure surface can be flat. It can extend laterally to provide a cutting surface. It can terminate in a scissor cutting edge. The flat surface encompasses the marginal crimping areas of the bread pieces. In practice, the apparatuses shown in FIGS. 8 and 9 are preferred to make the sandwich around central composite layer 20. Assembled bread slices and central layer 20 as shown in FIG. 4, irrespective of the process to obtain layer 20, is supported on platen P″ with pressure surface 400 large enough to match or encompass the marginal crimping areas of the final sandwich S. The surface also extends outward to give a cutting surface for knife or cutter 402 moved vertically by pneumatic cylinder 410 to cut the bread slices 70, 100 into the desired shape. An internal crimper 420 in the form of a crimping die with projections 422 is moved vertically by pneumatic cylinder 424. Bottom edge 426 of crimping die 420 has a shape matching the cut shape of cutter 402 and is spaced inwardly to give a generally constant force gradient over the marginal areas of the slices cut to form sandwich S. The cutting action is typically first and separate from the crimping action. The sandwich is formed with small forces, if any, to compress the bread in the center. When the marginal layers are crimped together, they are joined by the sticking action experienced when forming dough balls from fresh white bread.

The invention has been described with reference to a preferred embodiment and alternates thereof. It is believed that many modifications and alterations to the embodiments disclosed will readily suggest themselves to those skilled in the art upon reading and understanding the detailed description of the invention. It is intended to include all such modifications and alterations insofar as they come within the scope of the present invention.

Having thus defined the invention, the following is claimed:

1. A method of making a sandwich from two slices of bread, said method comprising:
(a) selecting a first slice of bread;
(b) forming a first layer of a first food spread on said first slice of bread, said first layer of a first food spread spaced inwardly from a peripheral edge of said first slice of bread;
(c) placing a second food spread on said first layer of said first food spread, said second food spread spaced at least partially inwardly from a peripheral edge of said first layer of said first food spread;
(d) placing a second layer of said first food spread over said second food spread, said second layer of said first food spread having a peripheral edge that is positioned closely adjacent to said peripheral edge of said first layer of said first food spread so as to at least partially encapsulate said second food spread between said first and second layer of said first food spread to form a central composite food layer, said peripheral edge of said second layer of said first food spread spaced inwardly from a peripheral edge of said first slice of bread, at least one of said layers of said first food spread being nutritionally enhanced;
(e) placing a second slice of said bread over said first slice to cover said center composite food layer, said second slice of said bread having a peripheral edge;
(f) pressing a region at least closely adjacent to said peripheral edge of at least one of said bread slices to at least partially crimp said slices into a sandwich at least partially about a peripheral edge of said central composite food layer, said crimp substantially absent said first and second food spread.

2. The method as defined in claim 1, wherein both layers of said first food spread being nutritionally enhanced.

3. The method as defined in claim 1, wherein said nutritionally enhanced first food spread includes a nutritional enhancer, said nutritional enhancer including a protein supplement, a vitamin supplement, a mineral supplement, a fiber supplement, or combinations thereof.

4. The method as defined in claim 2, wherein said nutritionally enhanced first food spread includes a nutritional enhancer, said nutritional enhancer including a protein supplement, a vitamin supplement, a mineral supplement, a fiber supplement, or combinations thereof.

5. The method as defined in claim 3, wherein said nutritional enhancer includes a protein supplement.

6. The method as defined in claim 4, wherein said nutritional enhancer includes a protein supplement.

7. The method as defined in claim 1, wherein said first food spread includes a nutritionally enhanced nut butter and said second food spread includes jelly.

8. The method as defined in claim 6, wherein said first food spread includes a nutritionally enhanced nut butter and said second food spread includes jelly.

9. The method as defined in claim 1, including the step of at least partially forming said nutritionally enhanced first food spread from pre-made nut butter and mixing a nutritional enhancer with said pre-made nut butter.

10. The method as defined in claim 3, including the step of at least partially forming said nutritionally enhanced first food spread from pre-made nut butter and mixing a nutritional enhancer with said pre-made nut butter.

11. The method as defined in claim 8, including the step of at least partially forming said nutritionally enhanced first food spread from pre-made nut butter and mixing a nutritional enhancer with said pre-made nut butter.

12. The method as defined in claim 9, including the step of mixing a flavoring agent with said pre-made nut-butter.

13. The method as defined in claim 11, including the step of mixing a flavoring agent with said pre-made nut-butter.

14. The method as defined in claim 12, wherein said nutritionally enhanced first food spread includes a flavoring agent, said flavoring agent including salt, spice, extract, sweetener, or combinations thereof.

15. The method as defined in claim 1, wherein said crimp includes a plurality of spaced apart depressions.

16. The method as defined in claim 13, wherein said crimp includes a plurality of spaced apart depressions.

17. The method as define in claim 15, wherein said depressions are generally spaced an equal distance from one another.

18. The method as defined in claim 1, wherein said sandwich has a substantially circular shape.

19. The method as defined in claim 1, including the step of sealing said sandwich in a substantially air tight package.

20. The method as defined in claim 1, wherein said first slice of bread is placed on a platen with a central portion and a pressure surface surrounding said central portion, said central composite food layer spaced at least partially inwardly of said pressure surface, said crimp at least partially formed by pressing a portion of at least one of said bread slices toward said pressure surface of said platen.

21. The method as defined in claim 16, wherein said first slice of bread is placed on a platen with a central portion and a pressure surface surrounding said central portion, said central composite food layer spaced at least partially inwardly of said pressure surface, said crimp at least partially formed by pressing a portion of at least one of said bread slices toward said pressure surface of said platen.

22. The method as defined in claim 20, wherein said central portion of said platen is recessed.

23. The method as defined in claim 21, wherein said central portion of said platen is recessed.

24. The method as defined in claim 20, wherein said pressure surface includes spaced projections to create depressions in at least said first slice of bread to at least partially form spaced pressure points in said crimp.

25. The method as defined in claim 20, wherein said pressing act is at least partially performed by an upper pressure plate with a lower pressure surface overlying said pressure surface of said platen.

26. The method as defined in claim 25, wherein said lower pressure surface includes spaced projections to create depressions in at least said second slice of bread to at least partially form spaced pressure points in said crimp.

27. The method as defined in claim 1, wherein at least one of said bread slices includes a crust and including the step of at least partially cutting off said crust prior to forming said crimp.

28. The method as defined in claim 23, wherein at least one of said bread slices includes a crust and including the step of at least partially cutting off said crust prior to forming said crimp.

29. The method as defined in claim 1, wherein said first food spread has a water activity that is less than a water activity of said second food spread.

30. The method as defined in claim 28, wherein said first food spread has a water activity that is less than a water activity of said second food spread.

31. The method as defined in claim 1, wherein a weight percent of said second food spread is at least about 10% of a weight percent of said central composite food layer.

32. The method as defined in claim 30, wherein said first food spread has a water activity that is less than a water activity of said second food spread.

33. The method as defined in claim 1, wherein said first layer of first food spread includes a rim to at least partially define a receptacle for said second food spread.

34. The method as defined in claim 32, wherein said first layer of first food spread includes a rim to at least partially define a receptacle for said second food spread.

35. A method of making a nutritionally enhanced nut butter from a pre-made nut butter, said method comprising:
(a) selecting a pre-made nut butter;
(b) transporting said pre-made nut butter to a mixer;
(c) at least partially combining at least one nutritional enhancer with said pre-made nut butter in said mixer to form said nutritionally enhanced nut butter, said nutritional enhancer including a protein supplement, a vitamin supplement, a mineral supplement, a fiber supplement, or combinations thereof; and,
(d) transporting said nutritionally enhanced nut butter to a packaging process to package said nutritionally enhanced nut butter in a package, or to a food processing machine that at least partially produces a food product that includes said nutritionally enhanced nut butter.

36. The method as defined in claim 35, including the step of heating said nut butter prior to and/or during said mixing step.

37. The method as defined in claim 35, wherein said nutritionally enhanced nut butter includes a protein supplement.

38. The method as defined in claim 35, wherein said nut butter includes peanut butter.

39. The method as defined in claim 37, wherein said nut butter includes peanut butter.

40. The method as defined in claim 35, including the step of mixing a flavoring agent with said pre-made nut butter, said flavoring agent including salt, spice, extract, sweetener, or combinations thereof.

41. The method as defined in claim 39, including the step of mixing a flavoring agent with said pre-made nut butter, said flavoring agent including salt, spice, extract, sweetener, or combinations thereof.

42. The method as defined in claim 35, wherein said nutritional enhancer constitutes about 0.5-40 weight percent of said nutritionally enhanced nut butter.

43. The method as defined in claim 41, wherein said nutritional enhancer constitutes about 0.5-40 weight percent of said nutritionally enhanced nut butter.

44. The method as defined in claim 40, wherein said flavoring agent constitutes about 0.1-25 weight percent of said nutritionally enhanced nut butter.

45. The method as defined in claim 43, wherein said flavoring agent constitutes about 0.1-25 weight percent of said nutritionally enhanced nut butter.

46. The method as defined in claim 35, wherein said nutritionally enhanced nut butter comprises:

| | |
|---|---|
| Pre-made nut butter | 60-99 wt. % |
| Nutritional enhancer | 0.5-40 wt. % |
| Flavoring agent | 0-25 wt. % |

47. The method as defined in claim 46, wherein said nutritionally enhanced nut butter comprises:

| | |
|---|---|
| Pre-made nut butter | 60-99 wt. % |
| Protein Supplement | 0.5-40 wt. % |
| Vitamin/Mineral | 0-30 wt. % |
| Supplement | |
| Fiber Supplement | 0-25 wt. % |
| Flavoring agent | 0-25 wt. % |

48. The method as defined in claim 47, wherein said nutritionally enhanced nut butter comprises:

| | |
|---|---|
| Pre-made nut butter | 70-95 wt. % |
| Protein Supplement | 4-40 wt. % |
| Vitamin/Mineral | 0-20 wt. % |
| Supplement | |
| Fiber Supplement | 0-15 wt. % |
| Flavoring agent | 1-25 wt. % |

49. The method as defined in claim 45, wherein said nutritionally enhanced nut butter comprises:

| | |
|---|---|
| Pre-made nut butter | 70-95 wt. % |
| Protein Supplement | 4-40 wt. % |
| Vitamin/Mineral | 0-20 wt. % |
| Supplement | |
| Fiber Supplement | 0-15 wt. % |
| Flavoring agent | 1-25 wt. % |

50. The method as defined in claim 48, wherein said nutritionally enhanced nut butter comprises:

| | |
|---|---|
| Pre-made nut butter | 70-85 wt. % |
| Protein Isolate | 10-20 wt. % |
| Calcium | 0-10 wt. % |
| Fiber | 0-10 wt. % |
| Salt and Sweetener | 4-15 wt. % |

51. The method as defined in claim 49, wherein said nutritionally enhanced nut butter comprises:

| | |
|---|---|
| Pre-made nut butter | 70-85 wt. % |
| Protein Isolate | 10-20 wt. % |
| Calcium | 0-10 wt. % |
| Fiber | 0-10 wt. % |
| Salt and Sweetener | 4-15 wt. % |

52. The method as defined in claim 50, wherein said nutritionally enhanced nut butter comprises:

| | | |
|---|---|---|
| Pre-made peanut butter | 70-85 | wt. % |
| Soy Protein Isolate | 10-20 | wt. % |
| Calcium | 0-10 | wt. % |
| Sodium Chloride | 0.3-1.5 | wt. % |
| Dextrose | 3-8 | wt. % |

53. The method as defined in claim 51, wherein said nutritionally enhanced nut butter comprises:

| | | |
|---|---|---|
| Pre-made peanut butter | 70-85 | wt. % |
| Soy Protein Isolate | 10-20 | wt. % |
| Calcium | 0-10 | wt. % |
| Sodium Chloride | 0.3-1.5 | wt. % |
| Dextrose | 3-8 | wt. % |

54. A nutritionally enhanced nut butter derived from a pre-made nut butter comprising a majority of pre-made nut butter and about 0.5-40 weight percent of a subsequently added nutritional enhancer, said nutritional enhancer including a protein supplement, a vitamin supplement, a mineral supplement, a fiber supplement, or combinations thereof.

55. The nutritionally enhanced nut butter as defined in claim 54, wherein said nutritionally enhanced nut butter includes a protein supplement.

56. The nutritionally enhanced nut butter as defined in claim 54, wherein said nut butter includes peanut butter.

57. The nutritionally enhanced nut butter as defined in claim 54, including a subsequently added flavoring agent, said flavoring agent including salt, spice, extract, sweetener, or combinations thereof.

58. The nutritionally enhanced nut butter as defined in claim 55, including a subsequently added flavoring agent, said flavoring agent including salt, spice, extract, sweetener, or combinations thereof.

59. The nutritionally enhanced nut butter method as defined in claim 57, wherein said flavoring agent constitutes about 0.1-25 weight percent of said nutritionally enhanced nut butter.

60. The nutritionally enhanced nut butter method as defined in claim 58, wherein said flavoring agent constitutes about 0.1-25 weight percent of said nutritionally enhanced nut butter.

61. The nutritionally enhanced nut butter defined in claim 54, wherein said nutritionally enhanced nut butter comprises:

| | |
|---|---|
| Pre-made nut butter | 60-99 wt. % |
| Nutritional enhancer | 0.5-40 wt. % |
| Flavoring agent | 0-25 wt. % |

62. The nutritionally enhanced nut butter as defined in claim 61, wherein said nutritionally enhanced nut butter comprises:

| | |
|---|---|
| Pre-made nut butter | 60-99 wt. % |
| Protein Supplement | 0-40 wt. % |
| Vitamin/Mineral | 0-30 wt. % |
| Supplement | |
| Fiber Supplement | 0-25 wt. % |
| Flavoring agent | 0-25 wt. % |

63. The nutritionally enhanced nut butter method as defined in claim 62, wherein said nutritionally enhanced nut butter comprises:

| | |
|---|---|
| Pre-made nut butter | 70-95 wt. % |
| Protein Supplement | 4-40 wt. % |
| Vitamin/Mineral | 0-20 wt. % |
| Supplement | |
| Fiber Supplement | 0-15 wt. % |
| Flavoring agent | 1-25 wt. % |

64. The nutritionally enhanced nut butter method as defined in claim 60, wherein said nutritionally enhanced nut butter comprises:

| | |
|---|---|
| Pre-made nut butter | 70-95 wt. % |
| Protein Supplement | 4-40 wt. % |
| Vitamin/Mineral | 0-20 wt. % |
| Supplement | |
| Fiber Supplement | 0-15 wt. % |
| Flavoring agent | 1-25 wt. % |

65. The nutritionally enhanced nut butter as defined in claim 63, wherein said nutritionally enhanced nut butter comprises:

| | |
|---|---|
| Pre-made nut butter | 70-85 wt. % |
| Protein Isolate | 10-20 wt. % |
| Calcium | 0-10 wt. % |
| Fiber | 0-10 wt. % |
| Salt and Sweetener | 4-15 wt. % |

66. The nutritionally enhanced nut butter as defined in claim 64, wherein said nutritionally enhanced nut butter comprises:

| | |
|---|---|
| Pre-made nut butter | 70-85 wt. % |
| Protein Isolate | 10-20 wt. % |
| Calcium | 0-10 wt. % |
| Fiber | 0-10 wt. % |
| Salt and Sweetener | 4-15 wt. % |

67. The nutritionally enhanced nut butter as defined in claim 65, wherein said nutritionally enhanced nut butter comprises:

| | | |
|---|---|---|
| Pre-made peanut butter | 70-85 | wt. % |
| Soy Protein Isolate | 10-20 | wt. % |
| Calcium | 0-10 | wt. % |
| Sodium Chloride | 0.3-1.5 | wt. % |
| Dextrose | 3-8 | wt. % |

68. The nutritionally enhanced nut butter as defined in claim 66, wherein said nutritionally enhanced nut butter comprises:

| | | |
|---|---|---|
| Pre-made peanut butter | 70-85 | wt. % |
| Soy Protein Isolate | 10-20 | wt. % |
| Calcium | 0-10 | wt. % |
| Sodium Chloride | 0.3-1.5 | wt. % |
| Dextrose | 3-8 | wt. % |

69. A crustless sandwich made from at least two slices of baked bread, said sandwich comprising first and second matching crustless bread pieces, said bread pieces having the same general outer shape defined by an outer periphery with central portions surrounded by an outer peripheral region, said bread pieces being at least partially crimped together at said outer peripheral region, and a central composite food layer between said central portions and spaced inwardly of said crimped outer peripheral region, said composite food layer including a first and second layer of a first food spread and a second food spread substantially encapsulated between said first and second layer of said first food spread, said first food spread being nutritionally enhanced.

70. The crustless sandwich as defined in claim 69, wherein said nutritionally enhanced first food spread includes a nutritional enhancer, said nutritional enhancer including a protein supplement, a vitamin supplement, a mineral supplement, a fiber supplement, or combinations thereof.

71. The crustless sandwich as defined in claim 70, wherein said nutritional enhancer includes a protein supplement.

72. The crustless sandwich as defined in claim 69, wherein said first food spread includes nut butter and said second food spread includes jelly.

73. The crustless sandwich as defined in claim 71, wherein said first food spread includes nut butter and said second food spread includes jelly.

74. The crustless sandwich as defined in claim 69, wherein said nutritionally enhanced food spread includes a nutritionally enhanced nut butter formed from pre-made nut butter that was subsequently combined with a nutritional enhancer and a flavoring agent, said nutritional enhancer including a protein supplement, a vitamin supplement, a mineral supplement, a fiber supplement, or combinations thereof, said flavoring agent including salt, spice, extract, sweetener, or combinations thereof.

75. The crustless sandwich as defined in claim 69, wherein said nutritionally enhanced food spread includes a nutritionally enhanced nut butter formed from pre-made nut butter that was subsequently combined with a nutritional enhancer and a flavoring agent, said nutritional enhancer including a protein supplement, a vitamin supplement, a mineral supplement, a fiber supplement, or combinations thereof, said flavoring agent including salt, spice, extract, sweetener, or combinations thereof.

76. The crustless sandwich as defined in claim 69, wherein said crimped outer periphery area includes a plurality of spaced apart depressions.

77. The crustless sandwich as defined in claim 75, wherein said crimped outer periphery area includes a plurality of spaced apart depressions.

78. The crustless sandwich as defined in claim 76, wherein said depressions are generally spaced an equal distance from one another.

79. The crustless sandwich as defined in claim 76, wherein said depressions are at least partially spaced from said outer peripheral edge of said sandwich.

80. The crustless sandwich as defined in claim 69, wherein said sandwich has a substantially circular shape.

81. The crustless sandwich as defined in claim 69, wherein said first food spread has a water activity that is less than a water activity of said second food spread.

82. The crustless sandwich as defined in claim 77, wherein said first food spread has a water activity that is less than a water activity of said second food spread.

83. The crustless sandwich as defined in claim 69, wherein a weight percent of said second food spread is at least about 15% of a weight percent of said first and second layers of said central composite food layer.

84. The crustless sandwich as defined in claim 82, wherein a weight percent of said second food spread is at least about 15% of a weight percent of said first and second layers of said central composite food layer.

85. The crustless sandwich as defined in claim 69, wherein said crimped outer peripheral area has an average width of at least about 0.10 inch.

86. The crustless sandwich as defined in claim 84, wherein said crimped outer peripheral area has an average width of at least about 0.10 inch.

87. The crustless sandwich as defined in claim 69, wherein said composite food layer is generally circular.

88. The crustless sandwich as defined in claim 69, wherein said first layer of first food spread includes a rim to at least partially define a receptacle for said second food spread.

89. The crustless sandwich as defined in claim 86, wherein said first layer of first food spread includes a rim to at least partially define a receptacle for said second food spread.
